(19) United States
(12) Patent Application Publication
(10) Pub. No.: US 2012/0242617 A1
(43) Pub. Date: Sep. 27, 2012

(54) MIS-TOUCH AVOIDANCE METHOD AND APPARATUS OF MOBILE TERMINAL

(75) Inventor: Woo Cheol LEE, Suwon-si (KR)

(73) Assignee: SAMSUNG ELECTRONICS CO. LTD., Suwon-si (KR)

(21) Appl. No.: 13/428,476

(22) Filed: Mar. 23, 2012

(30) Foreign Application Priority Data
Mar. 24, 2011 (KR) 10-2011-0026275

(51) Int. Cl. G06F 3/045; G06F 3/041

(52) U.S. Cl. 345/174; 345/173

(57) ABSTRACT

A mis-touch avoidance method and apparatus for preventing an unintended touch made by noise generated by the attachment of an accessory or a user's grip from causing a malfunction of a mobile terminal including a touchscreen are provided. The mis-touch avoidance method includes detecting an attachment of an external device and recalibrating a reference value for touch recognition in response to the attachment of the external device. The mis-touch avoidance method also includes detecting a touch on the touchscreen, determining whether the touch is an unintended touch made by user's grip of the mobile terminal, and recalibrating a reference value for touch recognition when the touch is the unintended touch.

### PRIORITY

This application claims the benefit under 35 U.S.C. §119(a) of a Korean patent application filed on Mar. 24, 2011 in the Korean Intellectual Property Office and assigned Serial No. 10-2011-0026275, the entire disclosure of which is hereby incorporated by reference.

### BACKGROUND OF THE INVENTION

1. Field of the Invention

The present invention relates to a mobile terminal More particularly, the present invention relates to a mis-touch avoidance method and apparatus of the mobile terminal for preventing an unintended touch made by noise from attachment of an accessory or user's grip from causing malfunction of the mobile terminal.

2. Description of the Related Art

With the rapid advance of information communication and semiconductor technologies, there has been a corresponding increase in the use and popularity of mobile devices. Recent mobile devices are not just basic devices for providing dedicated services, such as voice communication or messaging services, but have become multifunctional devices supporting converged functions and services. As a representative mobile device, a mobile communication terminal incorporates diverse supplementary functions, including a TeleVision (TV) function, such as Digital Multimedia Broadcasting (DMB) and Digital Video Broadcasting (DVB), an audio playback function, such as Motion Picture Experts Group (MPEG)-1 or MPEG-2 Audio Layer-3 (MP3), a camera function, a data communication function, an Internet access function, a location information provision function, and other similar functions, as well as the basic voice communication and messaging functions.

In order to utilize the converged functions and services, the ability to quickly and conveniently manipulate a mobile terminal is an important factor for the performance of the mobile terminal. In order to improve the convenience of manipulation, the recent mobile terminals are equipped with a touch input device. The touch input device detects a physical change at a point where a touch is made and interprets the touch event as corresponding to a predetermined input command. For example, in a capacitive touch input device, electrical capacitance changes at the position where the touch is made, such that if the change in electrical capacitance is greater than a predetermined threshold or hysteresis, the change in electrical capacitance is regarded as a touch event that has occurred. More recently, mobile terminals having a 3×4 button keypad, i.e., a number pad, are being replaced by full touch mobile terminals equipped with a touchscreen as the touch input device. The full touch mobile terminal has a connection interface for accessories such as a charger, earphones, and a Universal Serial Bus (USB) cable, wherein the connection interface is arranged close to the touchscreen due to structural characteristics of the full touch mobile terminal. In such a configuration, noise, such as electrical interference, occurring when an external accessory is attached to the mobile terminal changes the electric capacity on the touchscreen, and may result in malfunction of the touchscreen.

Also, the full touch mobile terminal is vulnerable to a mis-touch made by unintended contact of user's hand on the touchscreen when the user grips the mobile terminal body, and the contact on the touchscreen may cause a subsequent or concurrent intended touch to be misrecognized. For example, the unintended contact to the touch screen made by the grip of the mobile terminal may cause the terminal to recognize the intended touch as a multi-touch. Some touchscreen-enabled mobile terminals are configured to wait until the unintended touch made by the grip is released. This is likely to cause overload of the mobile terminal, resulting in detection failure of intended touch. In order to solve this problem, a touchscreen-enabled mobile terminal may be provided with a touch protection region formed along the edge of the touchscreen so as to physically isolate the touchscreen from the grip of the terminal body. However, the touch protection region increases the size of the mobile terminal and gives a bad effect in design.

### SUMMARY OF THE INVENTION

Aspects of the present invention are to address at least the above-mentioned problems and/or disadvantages and to provide at least the advantages described below. Accordingly, an aspect of the present invention is to provide a mis-touch avoidance method and apparatus of a touchscreen-enabled mobile terminal that is capable of preventing the mobile terminal from malfunctioning.

Another aspect of the present invention is to provide a mis-touch avoidance method and apparatus of a touchscreen-enabled mobile terminal that is capable of preventing the terminal from malfunctioning due to electrical noise generated by attachment of an external accessory or device to the mobile terminal

Another aspect of the present invention is to provide a mis-touch avoidance method and apparatus of a touchscreen-enabled mobile terminal that is capable of preventing the mobile terminal from malfunctioning due to an unintended touch in griping the mobile terminal body.

In accordance with an aspect of the present invention, a mis-touch avoidance method for a mobile terminal is provided. The method includes detecting an attachment of an external device and recalibrating a reference value for touch recognition in response to the attachment of the external device.

In accordance with another aspect of the present invention, a mis-touch avoidance method for a mobile terminal is provided. The method includes detecting a touch on a touchscreen, determining whether the touch is an unintended touch made by a user's grip of the mobile terminal, and recalibrating a reference value for touch recognition when the touch is the unintended touch.

In accordance with yet another aspect of the present invention, a mis-touch avoidance apparatus for a mobile terminal is provided. The apparatus includes an interface unit for attachment of an external device, a touchscreen for detecting a touch, and a control unit for recalibrating a reference value for touch recognition when the attachment of the external device is detected.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of the mobile terminal according to an exemplary embodiment of the present invention;

FIG. 2 is a diagram illustrating a configuration of a touchscreen with a grip region according to an exemplary embodiment of the present invention;

FIG. 3 is a block diagram illustrating a configuration of a mobile terminal according to an exemplary embodiment of the present invention;

FIG. 4 is a flowchart illustrating a mis-touch avoidance method by an attachment of an external device of a mobile terminal according to the exemplary embodiment of FIG. 1;

FIG. 5 is a flowchart illustrating a mis-touch avoidance method an attachment of an external device of a mobile terminal according to the exemplary embodiment of FIG. 3;

FIG. 6 is a flowchart simply illustrating a mis-touch avoidance method by a user's grip;

FIG. 7 is a signaling diagram illustrating a mis-touch avoidance method according to the first exemplary embodiment of FIG. 6;

FIG. 8 is a signaling diagram illustrating a mis-touch avoidance method according to the second exemplary embodiment of FIG. 6;

FIG. 9 is a signaling diagram illustrating a mis-touch avoidance method according to the third an exemplary embodiment of FIG. 6;

FIG. 10 is a schematic diagram illustrating a format of a grip message for use in a mis-touch avoidance method according to an exemplary embodiment of FIG. 9;

FIG. 11 is a signaling diagram illustrating a mis-touch avoidance method according to the fourth an exemplary embodiment of FIG. 6;

FIG. 12 is a schematic diagram illustrating a format of a message including a configuration register for use in a mis-touch avoidance method according to the exemplary embodiments of FIGS. 9 and 11;

FIGS. 13A and 13B are a flowchart illustrating a mis-touch avoidance method according to another exemplary embodiment of the present invention; and

FIG. 14 is a flowchart illustrating a mis-touch avoidance method according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, the term “reference value” means the physical quantity (e.g., capacitance and resistance) of a touch panel where no touch is made. The reference value of the touch panel varies when the touch is made thereon. When the displacement of the reference value variation caused by the touch is greater than a predetermined threshold value, this is recognized as a touch.

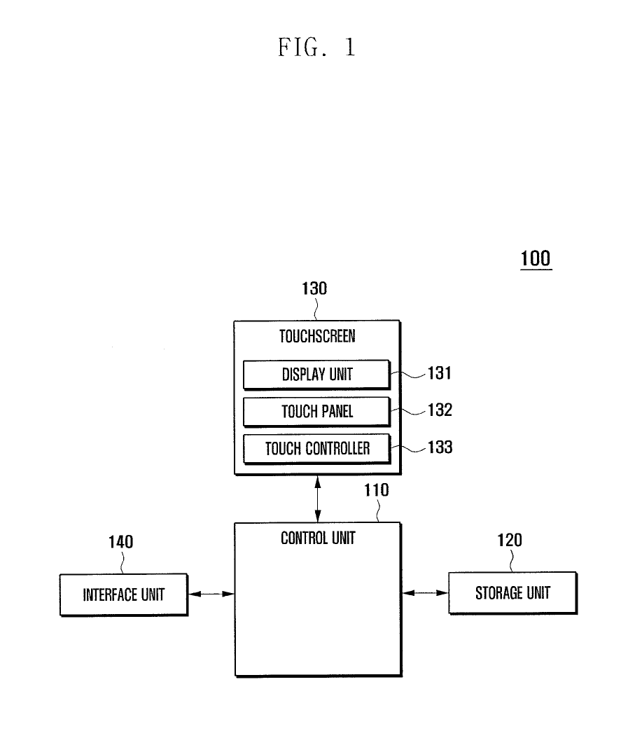

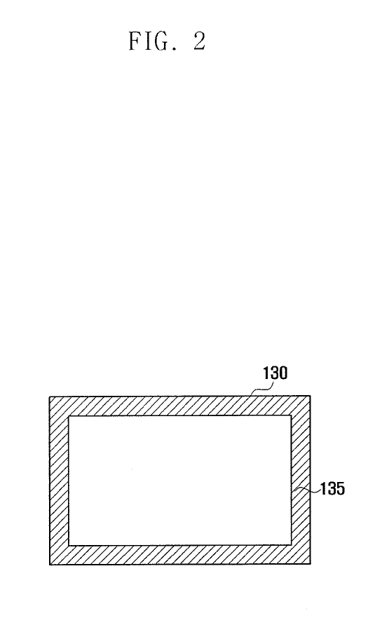

FIG. 1 is a block diagram illustrating a configuration of the mobile terminal according to an exemplary embodiment of the present invention, and FIG. 2 is a diagram illustrating a configuration of a touchscreen with a grip region according to an exemplary embodiment of the present invention.

Referring to FIGS. 1 and 2, a mobile terminal 100 according to the exemplary embodiment of FIG. 1 of the present invention includes an interface unit 140, a touchscreen 130, a storage unit 120, and a control unit 110. The touchscreen 130 may include a display unit 131, a touch panel 132, and a touch controller 133.

The interface unit 140 is a device allowing for the attachment of external devices and accessories such as an earphone, a recharger, and a Universal Serial Bus (USB) cable, or other similar external devices and accessories. The devices and accessories that can be attached to the terminal through the interface unit 140 are referred to as external devices hereinafter. The interface unit 140 may be made of a metallic material. However, the present invention is not limited thereto and the interface unit 140 may be made of other suitable materials. The interface unit 140 transfers an interrupt signal to the control unit 110 when an external device is attached to the interface unit 140.

The touchscreen 130 provides the touch input function and screen output function, and includes the display unit 131, the touch panel 132, and the touch controller 133.

The display unit 131 displays information input by the user and information presented to the user as well as various menus, graphics and other information relating to the operation of the mobile terminal 100. For example, the display unit 131 provides various execution screens such as a standby mode screen, a message composition screen, and a call progression screen. The display unit 131 may be one of a Liquid Crystal Display (LCD), an Organic Light Emitting Diode (OLED) display, and Active Matrix OLED (AMOLED) display, or any other suitable display types.

The touch panel 132 is laminated so as to be on a surface of the display unit 131 such that a physical quantity (e.g., a capacitance) varies at the position where a touch is made. The touch panel 132 transfers the physical quantity variance caused by the touch to the touch controller 133.

The physical quantity variance may be transferred to the touch controller 130 as a message including variables such as X and Y channels for coordinate recognition, a number of channels, a release time, a vector value for touch movement, and a size of a touch region. The touch controller 133 communicates with the control unit 110 according to an 12C protocol. However, the present invention is not limited thereto, and any suitable protocol may be used for communication between the touch controller 133 and the control unit 110.

The touch controller 133 may include a touch detection processor (not shown) for detecting a touch, a message processor (not shown) for transferring the information, such as X and Y coordinates, to the control unit 110 in a read data format, a multi touch processor (not shown) for transferring the vector value for estimating movement direction of the touch, the size of the touched area, a number of touched points, the touch release time, and a touch pressure in the form of a message, a command processor (not shown) for executing commands such as a reset command, a test mode entry command, a power-up command, and a recalibration command, and a grip region processor (not shown) for configuring a grip region 135 (see FIG. 2) around the touch region. The touchscreen 130 includes the grip region 135 which is a region at which the user is likely to contact for holding the mobile terminal 100. Each processor and the respective processes may be assigned a process IDentifier (ID). The process ID is transmitted in the message. The process ID is stored in a table along with an address and a size of the process.

The storage unit 120 stores programs related to the functions and the user data according to an exemplary embodiment of the present invention. For example, the storage unit 120 may store basic programs for controlling general operations of the mobile terminal 100 and an Operating System (OS) for booting the mobile terminal 100. The storage unit 120 may also store application programs for supporting optional functions such as a camera function, an audio playback function, a still and motion picture playback function, a short range radio communication, a Near Field Communication (NFC) function, and other similar functions. The storage unit 120 stores the user data generated, such as text messages, game files, audio files, movie files, and other similar files or data, in the mobile terminal 100. Particularly, according to an exemplary embodiment of the present invention, the storage unit 120 stores a program for preventing the touchscreen 130 from malfunctioning due to the attachment of an external device, such as an accessory, or an unintended touch made in gripping the terminal.

The control unit 110 controls overall operations of the mobile terminal 100 and controls signaling among the internal function blocks of the mobile terminal 100. The control unit 110 may detect the attachment of an external device and transfer a reference value recalibration command for touch recognition to the touch controller 133. In more detail, the control unit 110 can transfer the recalibration command to the command process of the touch controller 133 according to the I2C communication protocol. At this time, after the attachment of the external device and after transfer of the recalibration command, it is preferred to ignore a touch made before receiving a recalibration complete message transmitted by the touch controller 133. The control unit 110 may again transfer the reference value recalibration command when the external device is detached so that the reference value changed by the attachment of the external device may be reverted to the original reference value.

The control unit 110 prevents the un-intended touch made by the user's grip of the mobile terminal 100 from causing a malfunction of the mobile terminal 100. The control unit 110 discriminates the un-intended touch from the intended touch and transfers the recalibration command to the touch controller 133 in order to recalibrate the reference value for touch recognition. For this purpose, the control unit 110 monitors the touch screen 130 in order to detect a touch made in the grip region 135 and determines, if a touch is detected in the grip region 135, the size of the touched area. That is, if the touched area is greater than a predetermined size, the control unit 110 determines the touch as being made by the user's grip of the mobile terminal 100. Additionally, in a case where a number of touch channels or a number of coordinates is greater than a threshold value, the control unit 110 determines that the touch is made by the user's grip of the mobile terminal 100.

When the touch caused by the user's grip is released, the control unit 110 transfers the reference value recalibration command to the touch controller 133. This is because, if the recalibrated reference value is maintained in the state where the user's grip is released, an intended touch may not be recognized by the touch controller 133. Accordingly, the mis-touch avoidance method and apparatus of the present exemplary embodiment prevents the unintended touch from causing a malfunction of the mobile terminal 100.

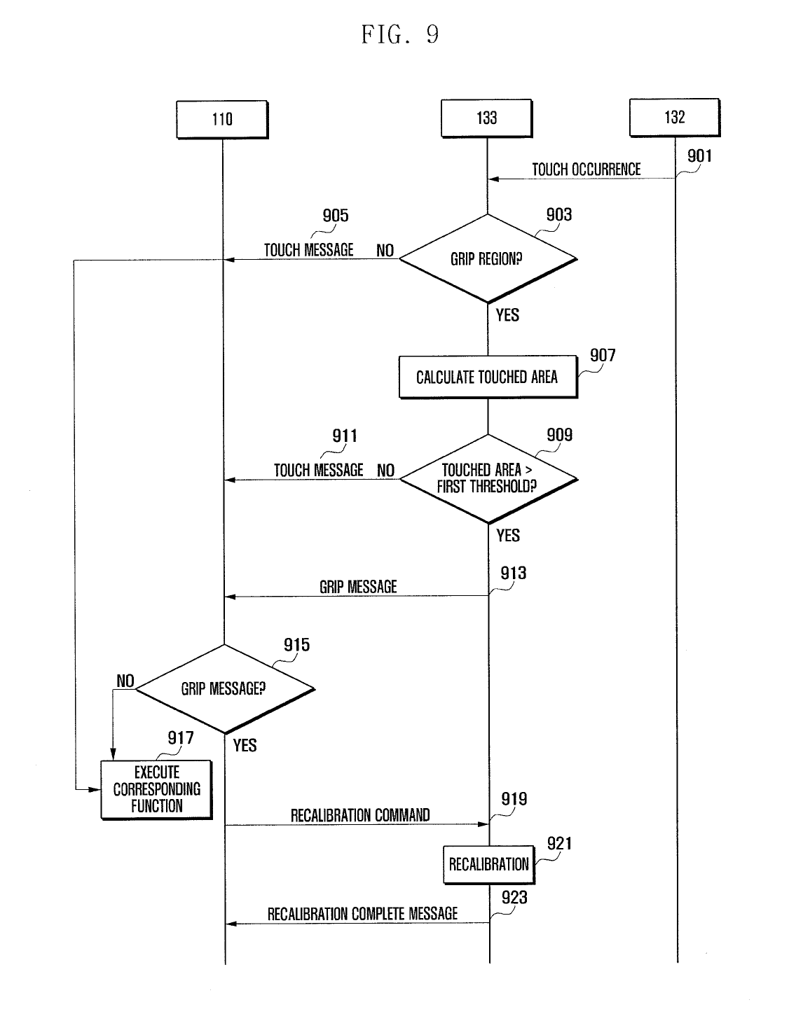

Although the description provided above is directed to a case where the touch controller 133 processes and accommodates the unintended touch made by the user's grip of the mobile terminal 100, the present invention is not limited thereto. For example, the touch controller 133 may only be responsible for a part of the procedure for preventing the mis-touch from causing a malfunction of the mobile terminal 100. This is described in detail with reference to FIGS. 9 to 12.

Although not depicted in FIG. 1, the mobile terminal 100 may include at least one of functional elements for other supplementary functions, such as a camera module, a broadcast reception module, a digital audio playback module (e.g., Moving Pictures Expert Group (MPEG)-1 or MPEG-2 audio layer-3 (MP3)) module, a short range wireless communication module, and an approach sensor or proximity sensor module for detecting an approach or a proximity of an object. Although not enumerated herein, the mobile terminal 100 may integrate the various devices equivalent to the aforementioned elements as far as they are can be converged.

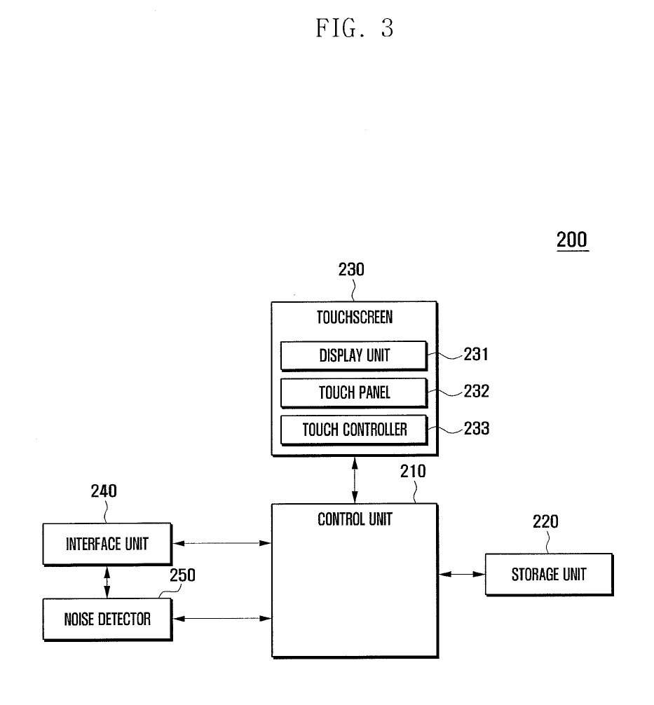

FIG. 3 is a block diagram illustrating a configuration of the mobile terminal according to an exemplary embodiment of the present invention.

Referring to FIG. 3, a mobile terminal 200 according to the present exemplary embodiment includes a noise detector 250, an interface unit 240, a touchscreen 230, a storage unit 220, and a control unit 210. The touchscreen 230 includes a display unit 231, a touch panel 232, and a touch controller 233. The mobile terminal 200 is largely similar to the mobile terminal 100 of FIG. 1, except for the noise detector 250 is added. Accordingly, a detailed description of common features and element are omitted herein for the purpose of brevity.

The noise detector 250 detects a noise occurrence and is interposed between the interface unit 240 and the control unit 110. The noise detector 250 determines an occurrence of noise by comparing a signal input through the interface unit 240 and the same signal passed through a Low Pass Filter (LPF) (not shown). The noise detector 250 includes the LPF to detect the noise occurrence. If noise is detected, the noise detector 250 notifies the control unit 210 of the noise occurrence in the form of an interrupt signal or message.

The control unit 210 detects the attachment of an external device through an interrupt node connected to the interface unit 240. If the attachment of the external device is detected, the control unit 210 activates the noise detector 250. Whereas, if the external device is detached, the control unit 210 deactivates the noise detector 250. If the noise occurrence notification signal is received from the noise detector 250, the control unit 210 transfers a reference value recalibration command to the touch controller 233. Upon receipt of the recalibration command, the touch controller 133 recalibrates the reference value and transfer a recalibration complete message to the control unit 210.

The mobile terminal 200 performs recalibration of the reference value when noise is detected rather than whenever the external device is attached to the mobile terminal 200 in order to minimize an operational delay caused by the reference value recalibration. The mobile terminal 200 may also be configured to detect noise caused by activation of the attached external device and prevent such noise from causing a malfunction of the touchscreen 230.

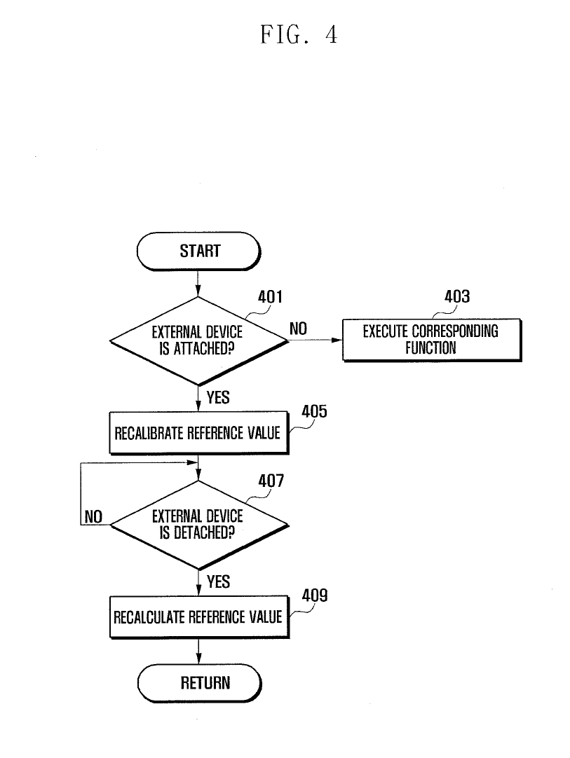

FIG. 4 is a flowchart illustrating a mis-touch avoidance method by an attachment of an external device of a mobile terminal according to the exemplary embodiment of FIG. 1.

Referring to FIGS. 1 and 4, the control unit 110 detects an occurrence of an event and, in step 401, determines whether the event is attachment of an external device. The attachment of the external device may be detected in the form of an interrupt signal or message or other suitable communication methods. The external device can be any of an earphone, a recharger, a USB cable, or any other suitable external device that is attachable to a mobile terminal 100. The interrupt-based device attachment detection is well known to those of ordinary skill in the art, and thus, a detailed description thereof is omitted herein.

If the detected event is determined to not be the attachment of the external device in step 401, then, in step 403, the control unit 110 executes a function corresponding to the event. For example, the control unit 110 may execute an audio playback function, a broadcast playback function, a file transfer function, or maintain the mobile terminal 100 in a standby mode, or perform any other similar function or operation. Otherwise, if the detected event is determined to be the attachment of the external device in step 401, then, in step 405, the control unit 110 recalibrates the reference value for the touch recognition.

In further detail, in step 405, the control unit 110 sends a reference value recalibration command to the touch controller 133. Then, in step 405, the touch controller 133 recalibrates the reference value and sends a reference value recalibration complete message to the control unit 110. At this time, after the reference value recalibration complete message has been sent, although not required in all embodiments of the present invention, the control unit 110 ignores the touch input before the reference value recalibration complete message is received by the control unit 110.

In step 407, the control unit 110 monitors the interface unit 140 in order to detect whether the external device is detached. The control unit 110 keeps monitoring the interface unit 140 until detachment of the device is detected. If the external device is detached, then in step 409, the control unit 110 recalibrates or recalculates the reference value. That is, the control unit 110 sends the reference value recalibration command to the touch controller 133 to recalculate the reference value.

As described above, the mis-touch avoidance method, according to the exemplary embodiment of FIG. 4, recalibrates the reference value for touch recognition according to the attachment or detachment of the external device, thereby preventing an unintended touch from causing a malfunction of the mobile terminal.

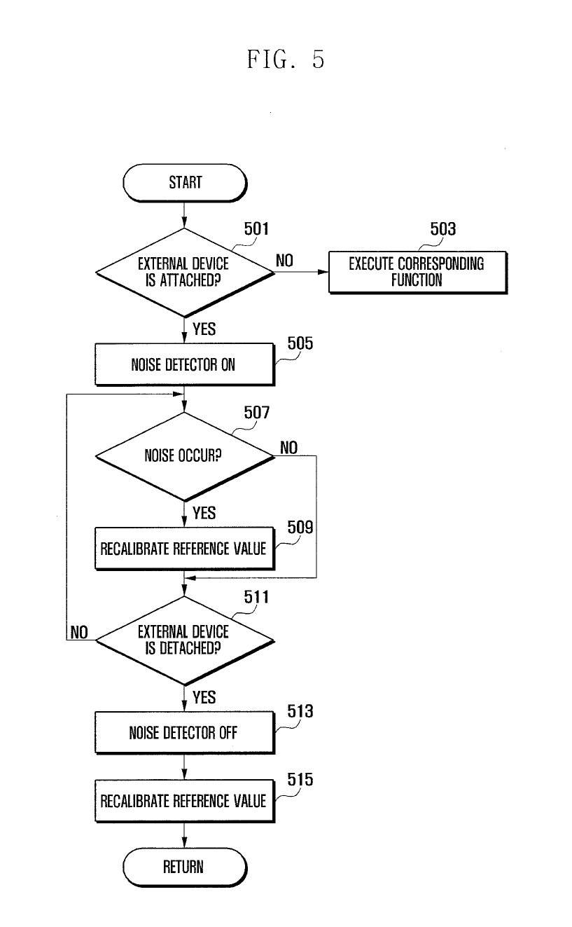

FIG. 5 is a flowchart illustrating a mis-touch avoidance method by an attachment of an external device of a mobile terminal according to the exemplary embodiment of FIG. 3.

Referring to FIGS. 3 and 5, the control unit 210 detects an occurrence of an event and, in step 501, determines whether the event is the attachment of an external device. If the detected event is not the attachment of the external device, then, in step 503, the control unit 110 executes the function corresponding to the event. Otherwise, if the event detected in step 501 is the attachment of the external device, then, in step 505, the control unit 110 activates the noise detector 250. In the present exemplary embodiment, the noise detector 250 may be installed so as to be connected to some of the lines or wire interconnecting the interface unit 240 and the control unit 210. That is, the noise detector 250 can be installed to connect to some or all of the interface lines between the interface unit 240 and the control unit 210.

Next, in step 507, the control unit 210 determines whether noise is detected. That is, the control unit 210 determines whether an interrupt signal or message for notifying of the noise occurrence is received. If no noise is detected, then the procedure goes to step 511. Otherwise, if noise is detected, then in step 509, the control unit 210 recalibrates the reference value for touch recognition. In further detail, in step 509, the control unit 210 sends the reference value recalibration command to the touch controller 233. Then, the touch controller 233 recalibrates the reference value and sends the reference value recalibration complete message to the control unit 210. Although not required in all embodiments of the present invention, after the detection of the noise, the control unit 210 ignores a touch input before receiving the reference value recalibration complete message from the touch controller 233.

Next, in step 511, the control unit 210 monitors the interface unit 240 in order to determine whether the external device is detached. If the external device is not detached in a predetermined time, the control unit 207 returns the procedure to step 507. Otherwise, if the external device is detached, then, in step 513, the control unit 210 deactivates or turns off the noise detector 250 and then, in step 515, recalibrates the reference value. That is, the control unit 210 transmits the reference value recalibration request to the touch controller 233.

As described above, the mobile terminal 200 recalculates the reference value for touch recognition when the attachment of an external device is detected so as to avoid a malfunction caused by an unintended touch.

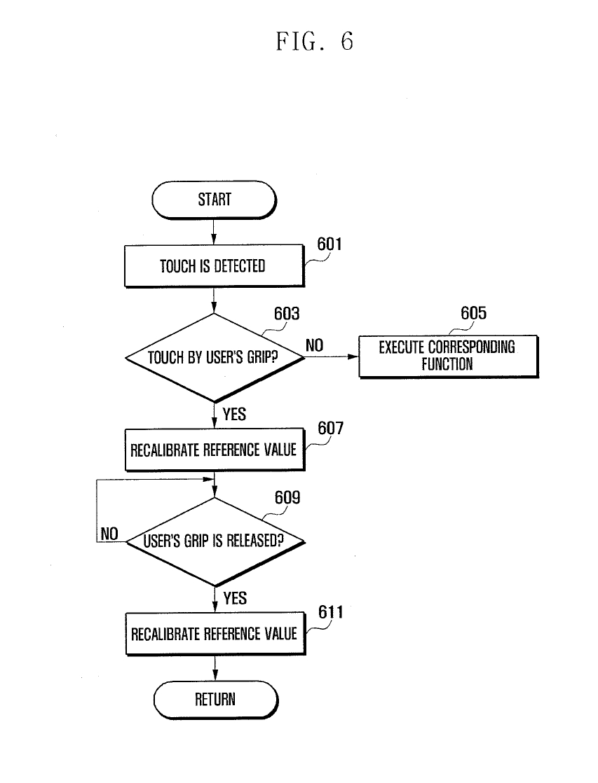

Hereinafter, FIGS. 6 to 14 will be described based on the mobile terminal 100 of FIG. 1. However, a description of FIGS. 6 to 14 can also be applied to the mobile terminal 200 of FIG. 3.

FIG. 6 is a flowchart simply illustrating the mis-touch avoidance method by a user's grip.

Referring to FIG. 6, in step 601, the control unit 110 detects a touch made on the touchscreen 130. Once the touch is detected, then in step 603, the control unit determines whether the touch is an unintended touch made by user's grip. Whether the touch is unintended may be determined by checking at least one of a size of touched area, a pressure made by the touch, and a number of channels in the touched area. If, in step 603, it is determined that the touch is not unintended, then in step 605, the control unit 110 executes the function intended by the touch. For example, the control unit 110 may execute a function corresponding to a displayed icon on which the touch is made. Otherwise, if, in step 603, it is determined that the touch is unintended, such as a touch made by the user's grip, then, in step 607, the control unit 110 recalibrates the reference value for touch recognition.

Next, in step 609, the control unit 110 determines whether the user's grip is released, and if not, the control unit 110 continues monitoring the touch screen 130 until the user's grip is released. If the user's grip is released, then, in step 611, the control unit 110 recalibrates the reference value.

Although not depicted in FIG. 6, the mis-touch avoidance method according to the exemplary embodiment of FIGS. 1 and 6 may further comprise a step for determining whether the touch is detected in the grip region 135. In this case, if the touch is made outside of the grip region 135, the control unit 110 executes the function mapped to the touched area and, otherwise, if the touch is made in the grip region 135, proceeds to step 603 of the exemplary embodiment of FIG. 6.

The mis-touch avoidance method according to the present exemplary embodiment may further include a step for determining whether the touch is made in an active region of the touchscreen 130. Here, the active region is a region in which icons are presented or displayed on the touch screen 130, such that when a touch is made at a location of an icon, a function mapped to the touched icon is executed. In such a case, if the touch is detected to have occurred outside of the active region, then the control unit 110 recalibrates the reference value for touch recognition. Otherwise, if the touch is detected to have occurred in the active region, the control unit 110 determines whether the touch is made in the grip region 135. If the touch is detected to have occurred outside of the grip region 135, then the control unit 110 performs the function mapped to the touched area. Otherwise if the touch is detected to have occurred in the grip region 135, the control unit 110 proceeds to perform step 603.

As described above, the mis-touch avoidance method of the present exemplary embodiment recalibrates the reference value for touch recognition when the unintended touch occurs only in a touch region due to the user's grip of the mobile terminal, so as to prevent the unintended touch from causing a malfunction of the mobile terminal The mis-touch avoidance method of the present exemplary embodiment has been described schematically and will be described in more detail hereinafter.

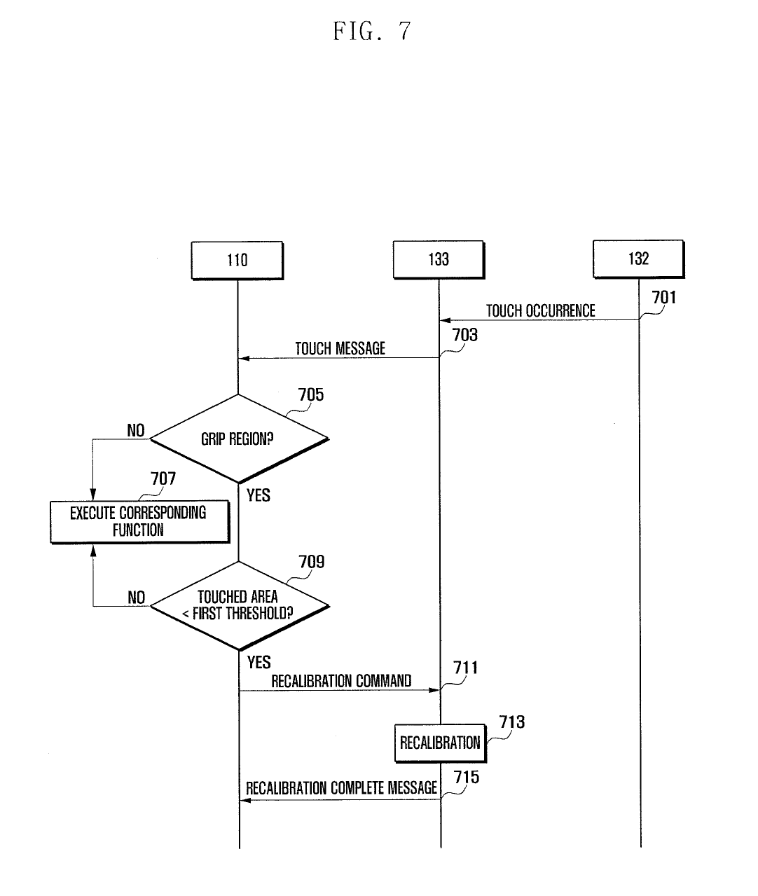

FIG. 7 is a signaling diagram illustrating the mis-touch avoidance method according to the first exemplary embodiment of FIG. 6.

Referring to FIG. 7, in step 701, the touch panel 132 sends a message indicating the occurrence of a touch made by a user to the touch controller 133. The occurrence of the touch is recognized by determining a displacement or a change of a physical quantity, such as an electrical capacity. Then, in step 703, the touch controller 133 transmits the message indicating the occurrence of the touch (hereinafter, referred to touch message) to the control unit 110. In further detail of step 703, the touch controller 133 generates an interrupt signal or message for transmitting the touch message to the control unit 110 and releases the interrupt signal or message after the transmission of the touch message. At this time, the control unit 110 and the touch controller 133 perform an error checking process. The error checking process may be performed using a checksum or any other suitable error checking process, and because the error checking process is well known to those of ordinary skill in the art, detailed description thereof is omitted herein.

If the touch message is received in step 703, then, in step 705, the control unit 110 analyzes the touch message in order to determine whether the touch occurs in the grip region 135. If the touch occurs outside of the grip region 135, then, in step 707, the control unit 110 executes an appropriate function corresponding to the touch. For example, the control unit 110 may perform the function mapped to the touched area. Otherwise, if, in step 705, it is determined that the touch occurs inside of the grip region 135, then, in step 709, the control unit 110 determines whether the size of the touched area is less than a first threshold value. If the size of the touched area is less than the first threshold value, then the control unit 110 proceeds to step 707 in order to execute the function mapped to the touched area. That is, if the size of the touched area is less than the first threshold value, the control unit 110 determines that the touch is the intended touch, and proceeds to perform the function mapped to the touched area. Otherwise, if, in step 709, it is determined that the size of the touched area is greater than the first threshold value, then, in step 711, the control unit 110 sends a reference value recalibration command to the touch controller 133. The recalibration command may be transmitted as an I2C Write command.

Upon receipt of the reference value recalibration command, the touch controller 133 performs recalibration of the reference value in step 713. When the reference value recalibration is done, then in step 715, the touch controller 133 sends a recalibration complete message to the control unit 110. In this manner, if the reference value is calibrated when an unintended touch is made on the touch panel 132 by the user's grip, the displacement or change of the physical quantity caused the unintended touch by the user's grip doesn't exceed the threshold value, and as such, is ignored. Accordingly, it is possible to prevent the unintended touch made by the user's grip from causing a malfunction of the mobile terminal.

Although not shown in FIG. 7, if it is determined that the unintended touch made by the user's grip is released, then the control unit 110 may send the reference value recalibration command to the touch controller 133. This is done so as to revert the reference value changed by the detection of the unintended touch to the original value such that an intended touch can be detected normally after the unintended touch has been released.

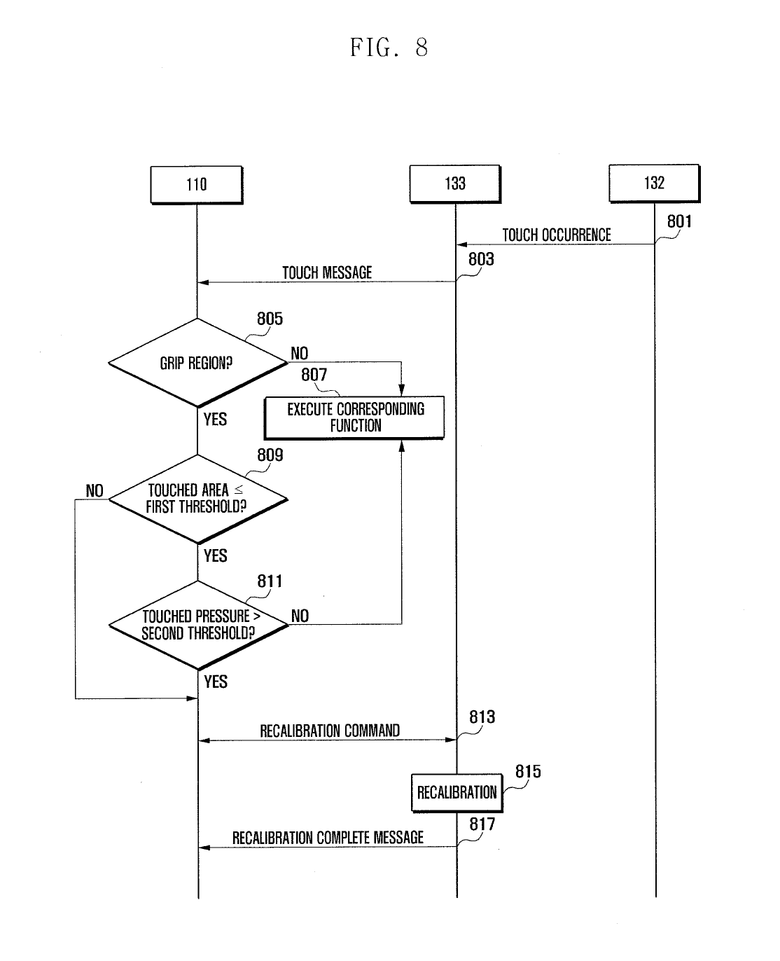

FIG. 8 is a signaling diagram illustrating the mis-touch avoidance method according to the second exemplary embodiment of FIG. 6.

Referring to FIG. 8, in step 801, the touch panel 132 sends a touch occurrence signal to the touch controller 133. The touch controller 133, in step 803, sends a touch message to the control unit 110. In detail, the touch controller 133 generates an interrupt signal or message to transfer the touch message to the control unit 110 and releases the interrupt after the transmission of the touch message. At this time, the control unit 110 and the touch controller 133 performs an error checking process. The error checking process may be performed using a checksum or any other suitable error checking processes, which are well known to those of ordinary skill in the art, and thus, detailed description thereof is omitted herein.

If the touch message is received by the control unit 110, then, in step 805, the control unit 110 analyzes the touch message in order to determine whether the touch occurred in the grip region 135. If it is determined, in step 805, that the touch occurred outside of the grip region 135, then, in step 807, the control unit 110 executes a corresponding function of the touch, such as a function mapped to the touched area. Otherwise, if it is determined in step 805 that the touch occurs in the grip region 135, then, in step 809, the control unit 110 determines whether a size of the touched area is equal to or less than a first threshold value. If the size of the touched area is greater than the first threshold value, the procedure goes to step 813, wherein the control unit 110 sends a reference value recalibration command to the touch controller 133.

Otherwise, if the size of the touched area is equal to or less than the first threshold value, then, in step 811, the control unit 110 determines whether a touch pressure is greater than a second threshold value, which may be a hysteresis value. That is, if the displacement of or change in the electrical capacity, which is caused by the touch, is out of the range of the hysteresis, the control unit 110 determines that excessive pressure has occurred. The control unit 110 makes this determination according to the characteristic that a pressure caused by a normal touch is less than the pressure caused by the user's grip. For example, it is possible to use the phenomenon that the touched area increases as a pressure applied by a finger on the touchscreen 230 increases. That is, in a case where the displacement of or change in the electrical capacity, which is caused by the increase of the size of the touch area, exceeds the hysteresis value, then the control unit 110 determines that excessive pressure has occurred. Although not required in all embodiments of the present invention, the touchscreen 230 may include a separate pressure sensing means.

If, in step 811, it is determined that the touch pressure is not greater than the second threshold value, then the control unit 110 proceeds to step 807 and performs the function corresponding to the touched area. That is, the control unit 110 regards the touch as the user's intended touch so as to perform the function mapped to the touched area. Otherwise, if, in step 811, it is determined that the touch pressure is greater than the second threshold value, then in step 813, the control unit 110 sends the reference value recalibration command to the touch controller 133. Upon receipt of the recalibration command, in step 815, the touch controller 133 recalibrates the reference value for touch recognition. After completing the recalibration of the reference value, then in step 817, the touch controller 133 sends a recalibration complete message to the control unit 110.

Although not depicted in FIG. 8, if it is determined that the user's grip has been released, then the control unit 110 sends the reference value recalibration command to the touch controller 133 in order to revert the reference value to an original value.

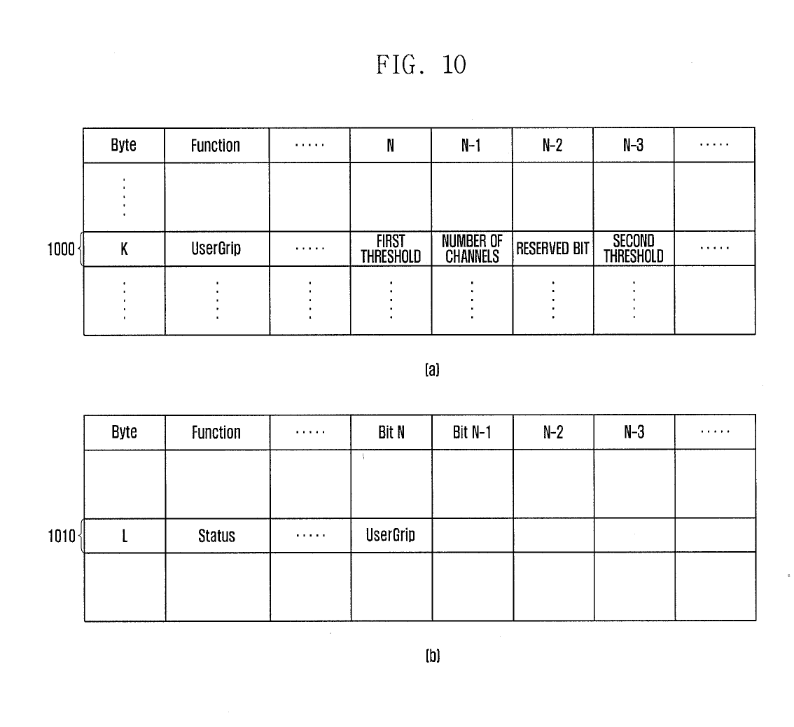

FIG. 9 is a signaling diagram illustrating a mis-touch avoidance method according to the third an exemplary embodiment of FIG. 6, and FIG. 10 is a schematic diagram illustrating a format of a grip message for use in a mis-touch avoidance method according to an exemplary embodiment of FIG. 9.

Referring to FIGS. 9 and 10, in step 901, a touch panel 132 sends the touch occurrence signal to a touch controller 133. Next, in step 903, the touch controller 133 determines whether the touch is made in a grip region 135. If it is determined that the touch is made outside of the grip region 135 in step 903, then the touch controller 133 sends a message notifying of the touch occurrence (a touch message) to a control unit 110 in step 905. After the touch message is received, the control unit 110 proceeds to step 917 and executes the function corresponding to the touched area. Otherwise, if it is determined that the touch is made in the grip region 135, then, in step 907, the touch controller 133 calculates the size of the touched area and determines whether a size of the touched area is greater than a first threshold value in step 909.

If the size of the touched area is not greater than the first threshold value, then, in step 911, the touch controller 133 regards the touch as an intended touch so as to send the touch message to the control unit 110. Otherwise, if the size of the touched area is greater than the first threshold value, then in step 913, the touch controller 133 regards the touch as an unintended touch and sends a grip message to the control unit 110.

The grip message may be transmitted in the format as shown in FIG. 10. The grip message is configured to have a new filed in addition to the fields constituting a related art message as shown in part (a) of FIG. 10. In part (a) of FIG. 10, a K^{th} byte is designated for a user grip field 1000 to indicate whether the touch is made by a user's grip. The user grip field 1000 can include an N^{th} bit indicating the first threshold, an (N−1)^{th} bit indicating the number of channels, and an (N−3)^{th} bit indicating the second threshold. Here, a (N−2)^{th} bit is a reserved bit for future use. Although the user grip field 1000 is configured as shown in part (a) of FIG. 10, and in the related art message, the grip field 1000 may be configured in different ways according to a designer's intention.

Furthermore, whether the touch is made by the user's grip also can be indicated through the reserved bit of a status field, as shown in part (b) of FIG. 10. For example, the N^{th} bit of a message field 1010 occupying an L^{th} byte of the message may be configured to carry a value indicating whether the touch is made by the user's grip, as shown in part (b) of FIG. 10. That is, the touch controller 133 may set the N^{th} bit of the message field 1010 to be 1 in order to indicate the touch made by the user grip or may set the N^{th} bit to be 0 in order to indicate the normal touch.

If a message is received from the touch controller 133, then, in step 915, the control unit 110 determines whether the received message is the grip message. That is, the control unit 110 checks the N^{th} bit of the message field 1010 of the message or whether the message includes the grip field 1000. If it is determined that the received message is not the grip message, then, in step 917, the control unit 110 executes the function corresponding to the touched area. Otherwise, if it is determined that the received message is the grip message, then, in step 919, the control unit 110 sends a recalibration command to the touch controller 133. Upon receipt of the recalibration command, the touch controller 133 performs recalibration of the reference value in step 921 and then sends a calibration complete message to the control unit 110 in step 923.

As described above, the mis-touch avoidance method according to an exemplary embodiment of the present invention is characterized in that the touch controller 133 executes some parts of the mis-touch avoidance procedure in order to reduce a processing load of the control unit 110 and sends the execution result to the control unit 110. Although not depicted in FIG. 9, if it is determined that the unintended touch made by the user's grip is released, then the control unit 110 may send the reference value recalibration command to the touch controller 133 in order to revert the reference value to an original value.

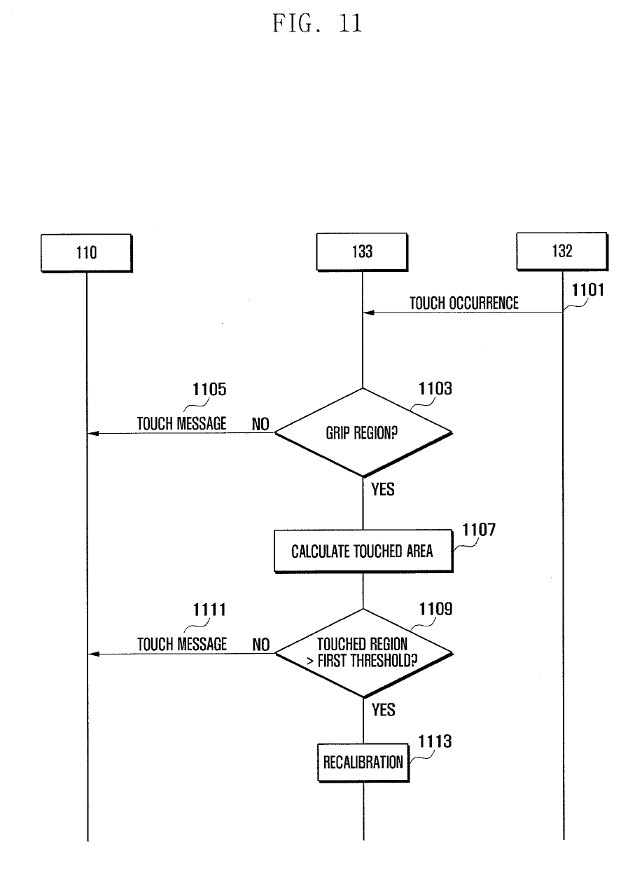

FIG. 11 is a signaling diagram illustrating the mis-touch avoidance method according to the fourth an exemplary embodiment of FIG. 6.

Referring to FIG. 11, in step 1101, the touch panel 132 sends the touch occurrence signal to the touch controller 133. Next, the touch controller 133 determines whether the touch is made in the grip region 135 in step 1103. If the touch is made outside of the grip region 135, then the touch controller 133 sends a touch message informing of normal touch to the control unit 110 in step 1105. If the touch message is received, although not shown, the control unit 110 executes the function corresponding to the touched area. Otherwise, if the touch is made in the grip region 135, the touch controller 133 calculates the size of the touched area in step 1107 and then determines whether the size of the touched area is greater than a first threshold value in step 1109.

If the size of the touched area is not greater than the first threshold value, then the touch controller 133 regards the touch as an intended touch so as to send the touch message to the control unit 110 in step 1111. Otherwise, if the size of the touched area is greater than the first threshold value, then, in step 1113, the touch controller 133 recalibrates the reference value for touch recognition. The mis-touch avoidance method according to the exemplary embodiment of FIG. 11 is characterized by the touch controller 133 performing the entire mis-touch avoidance procedure for preventing the unintended touch made by the user's grip from causing a malfunction of the mobile terminal. The touch controller 133 may be configured to transmit a recalibration notification message to the control unit 110 according to the designer's intention. The recalibration notification can be done by using a reserved bit of a status field in the related art message. That is, the status field of the message can be set to 1 in order to notify the control unit 110 that the recalibration has been executed.

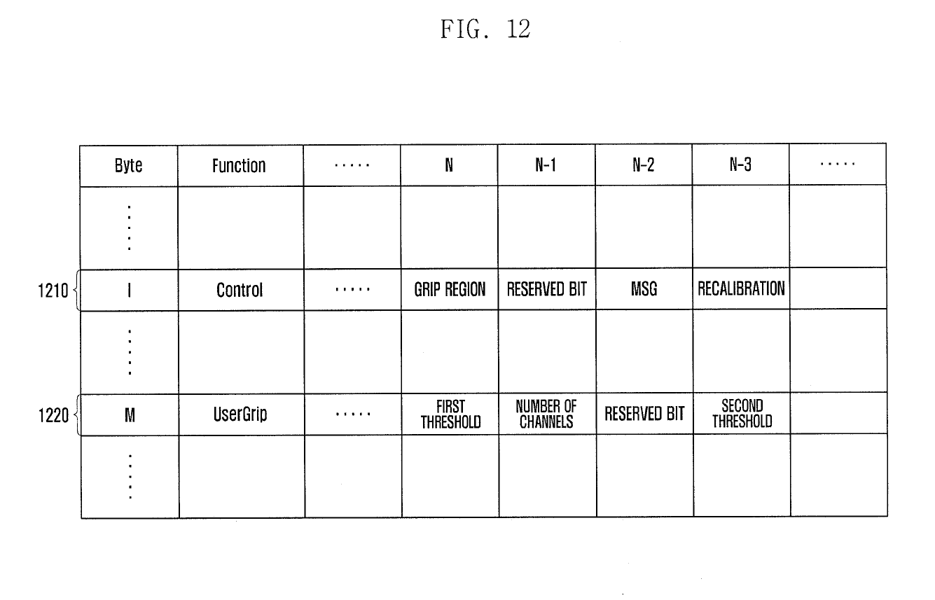

FIG. 12 is a schematic diagram illustrating a format of a message including a configuration register for use in the mis-touch avoidance method according to the exemplary embodiments of FIGS. 9 and 11.

Referring to FIG. 12, the message includes an I^{th} byte designated as a control field 1210 and an M^{th} byte designated as a user grip field 1220.

The control field 1210 is for controlling the procedure for ignoring the unintended touch made by a user's grip. The N^{th} bit of the control field 1210 indicates the result of determining whether the touch is made by the user's grip. The N^{th} bit is set to 1 for the touch controller 133 or 0 for the control unit 110. The (N−2)^{th} bit of the control field 1210 indicates whether to transmit the recalibration notification message. The (N−2)^{th} bit is set to 1 for indicating the transmission of the recalibration message from the touch controller 133 to the control unit or is set to 0 for indicating that the recalibration message is not transmitted. The (N−3)^{th} bit of the control field 1210 indicates a recalibration type. The (N−3)^{th} bit is set to 1 in order for the touch controller 133 to recalibrate the reference value without any explicit command and is set to 0 in order for the touch controller 133 to recalibrate the reference value according to a recalibration command.

In order for the touch controller 133 to determine the occurrence of the user's grip, perform recalibration, and send the recalibration notification message to the control unit 110 as shown in FIG. 11, the control field 1210 is configured such that all of the Nth, (N−2)^{th} , and (N−3)^{th} bits are set to 1. Meanwhile, in order for the touch controller 133 to determine the occurrence of the user's grip, perform recalibration, and send the recalibration complete message as shown in FIG. 9, the control field 1210 is configured such that the N^{th} and (N−2)^{th} bits are set to 1 and the (N−3)^{th} bit to 0.

The user grip field 1220 indicates the occurrence of the unintended touch made by the user's grip as described with reference to part (a) of FIG. 10. Whether to use the user grip field 1220 is determined according to whether the N^{th} bit is set or not. Since the user grip field 1220 has been described with reference to part (a) of FIG. 10 as the user grip field 1000, detailed description thereof is omitted herein. A configuration register of the touch controller 133 is configured as shown in FIG. 12, however, the present invention is not limited thereto and other suitable configurations of the configuration register may be used.

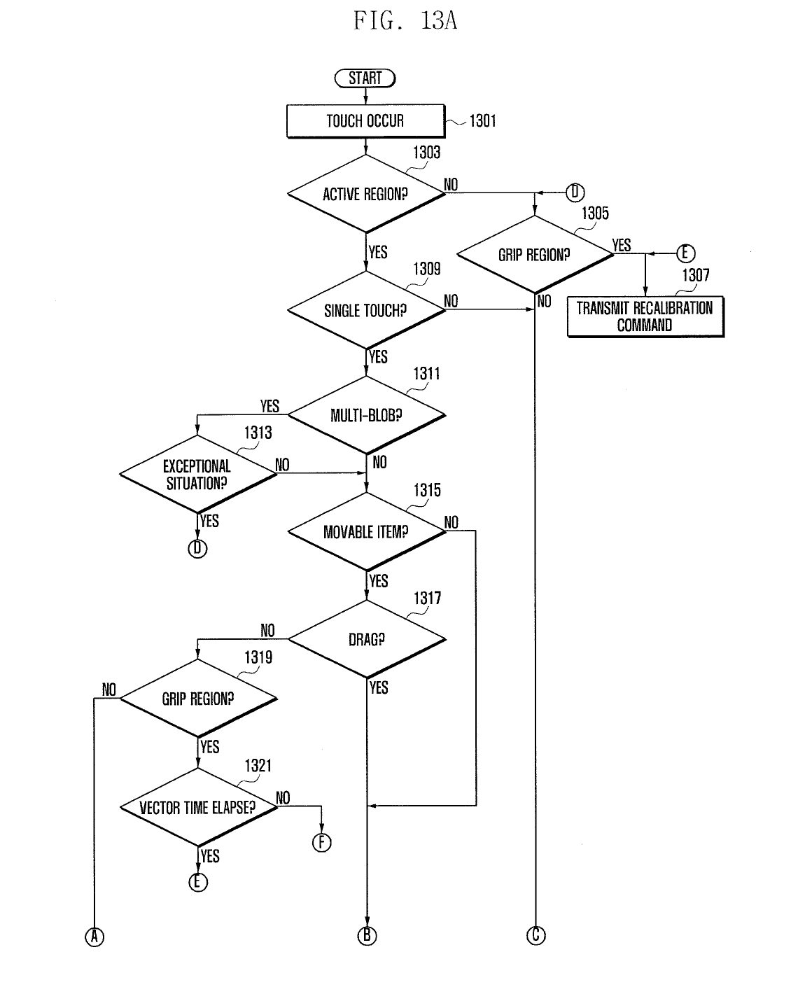

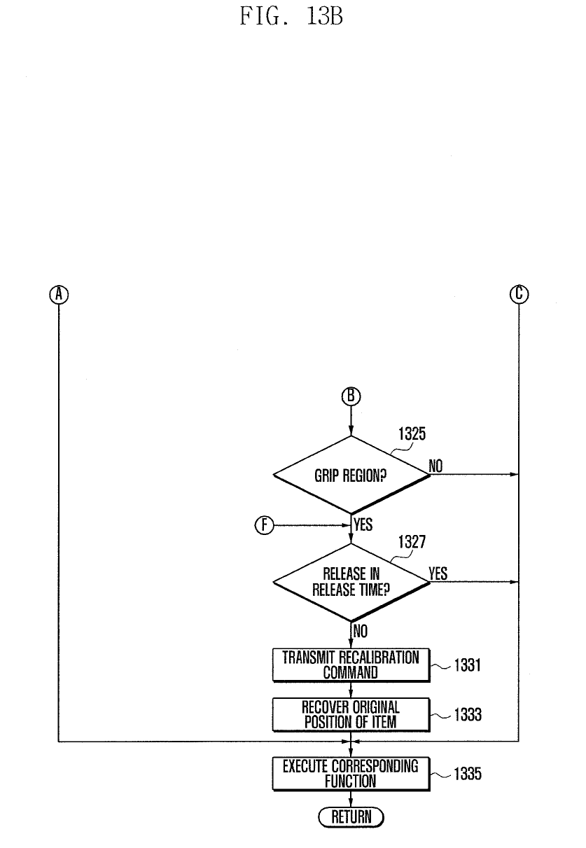

FIGS. 13A and 13B are flowcharts illustrating the mis-touch avoidance method according to another exemplary embodiment of the present invention. In the following description, the term “active region” means the region displaying icons mapped to the functions of which each can be executed by making a touch on the corresponding icon. The term “inactive region” means the region which is not responsive to any touch. The term “single touch” means the touch having a signal touch area. The signal touch can be categorized into one of single-blob and multi-blob. The term “single blob” means that the single touch area is formed in a signal region (active or inactive region), and the term “multi-blob” means that the single touch area is formed across multiple regions (active and inactive regions). The term multi-touch means the touch having multiple touch areas.

Referring to FIGS. 13A and 13B, the control unit 110 detects a touch by receiving the touch occurrence message from the touch controller 133 in step 1301. If a touch is detected, then the control unit 110 determines whether the touch is made in the active region in step 1303. If the touch is made outside of the active region, then the control unit 110 determines whether the touch is made in a predetermined grip region 135 in step 1305. If the touch is detected in the grip region, then the control unit 110 sends a recalibration command to the touch controller 133 in step 1307. Otherwise, in step 1305, if the touch is detected out of the grip region, then the control unit 110 executes the function corresponding to the touched area in step 1335. In this case, the touch is made in the inactive region such that the touch is recognized as not corresponding to the execution of any function.

If the touch is made in the active region at step 1303, then the control unit 110 determines whether the touch is a single touch in step 1309. If the touch is not the single touch (i.e. the touch is a multi-touch), then the control unit 110 executes the function corresponding to the multi-touch in step 1335. For example, if the multi-touch is input as a pinch gesture, then the control unit 110 may execute a zoom-out function. According to another exemplary embodiment, the control unit 110 can perform step 1319 in order to determine whether the multi-touch is made in the grip region. In a case where the multi-touch can be influenced by the user's grip, the control unit 110 performs step 1315, which is described below. The action in response to the multi-touch may vary according to a type of the control unit 133 and a configuration of the mobile terminal.

If the touch is determined to be the single touch at step 1309, then the control unit determines whether the single touch is a multi-blob single touch in step 1311. If the single touch is not the multi-blob single touch, then the control unit 110 performs step 1315, which is described below. Otherwise, if the single touch is the multi-blob single touch, then the control unit 110 determines whether the touch is an exceptional situation in step 1313. The exceptional situation includes situations in which an icon executable with a long touch and an icon executable with a short touch are multi-blobbed, the icons executable with the long touch are multi-blobbed, and the icons executable with the short touch are multi-blobbed. The exceptional situation may be determined according a configuration of the mobile terminal and a type of the touch controller 133.

If the touch is determined to be an exceptional situation at step 1313, the control unit 110 returns the procedure to step 1305. Otherwise, if the touch is determined to not be an exceptional situation at step 1313, then the control unit 110 determines whether the touch is made on a movable item in step 1315. The movable item is an item displayed on the touch screen 130 that can be moved by dragging a touch corresponding to the movable item. If the touch is not made on a movable item, then the control unit 110 performs step 1323 which is described below. Otherwise, if the touch is made on a movable item, then the control unit 110 detects whether the touch is dragged in step 1317. If the touch is dragged, then the control unit 110 performs step 1325 which is described below. Otherwise, if the touch is not dragged, then the control unit 110 determines whether the touch is made in the grip region 135 in step 1319.

If the touch is made outside of the grip region 135, then the control unit 110 executes the function mapped to the touched area in step 1335. For example, if the touch is the multi-blob single touch, then the control unit 110 executes the function corresponding to the icon that was first touched; and if the touch is the single blob single touch, then the control unit 110 executes the function corresponding to the icon at the touched area. If the touch is determined to be made in the grip region 135 at step 1319, then the control unit 110 determines whether a vector time has elapsed in step 1321. The vector time is a time period of waiting for the drag event to occur after an icon or item has been touched, such that if the vector time has elapsed without any movement of the touch, then this means that the item or icon has not been dragged. Once the vector time has elapsed, the control unit 110 sends the reference value recalibration command to the touch controller 133 in step 1307. Otherwise, if the vector time has not elapsed, the procedure goes to step 1327.

At step 1325, the control unit 110 determines whether the touch is made in the grip region 135. If the touch is made outside of the grip region 135, then the control unit 110 executes the function corresponding to the touched area in step 1335. Otherwise, if the touch is made in the grip region 135, then the control unit determines whether the touch is released within a predetermined release time in step 1327. If the touch is released within the predetermined release time, the control unit 110 executes the function corresponding to the touched area in step 1335.

Otherwise, if the touch is not released within the release time, the control unit 110 sends the reference value recalibration command to the touch controller 133 in step 1331 and then recovers the position of the moved item in step 1333. At this time, if there is no item moved or if the item is not a removable item, then step 1333 may be skipped. Finally, the control unit 110 executes the function mapped to the touched area in step 1335. For example, the control unit 110 can perform the function corresponding to the touch signal input through the touchscreen 130 of which a reference value for touch recognition has been recalibrated.

Although the description is directed to the case where the single touch is categorized into one of a single-blob and a multi-blob touch, this categorization may be ignored. That is, if the single touch is detected, then the control unit 110 skips step 1311 of FIG. 13A and determines whether the touch is an exceptional situation so as to perform step 1305 for the exceptional situation or step 1315 for the non-exceptional situation according to another exemplary embodiment of the present invention.

According to yet another exemplary embodiment of the present invention, the steps for processing the exceptional situation may be omitted. That is, the mis-touch avoidance method may be implemented so as to perform step 1315 when a single touch is detected, thus skipping steps 1311 and 1313 of FIG. 13A.

Although steps 1305, 1319, and 1325 for determining whether the touch is made in the grip region are depicted in FIGS. 13A and 13B, the present invention is not limited thereto. For example, the control unit 110 determines, if a touch is detected, whether the touch is made in the grip region 135, and, if the touch is made outside of the grip region 135, executes the function corresponding to the touched region. Otherwise, if the touch is made in the grip region 135, the control unit may execute the procedure described with reference to FIGS. 13A and 13B. In this case, since the grip region determination steps are executed when a touch is detected, the steps 1305, 1319, and 1325 can be omitted in the procedure illustrated in FIGS. 13A and 13B.

After performing step 1303 for determining whether the touch is made in the active region, the control unit 110, if the touch is made in the active region, may recalibrate the reference value and, otherwise, determine whether the touch is made in the grip region 135. If the touch is made outside of the grip region 135, then the control unit 110 may execute the function corresponding to the touched area. Otherwise, if the touch is made in the grip region 135, the control unit 110 may perform the procedure described with reference to FIGS. 13A and 13B since the step for determining the grip region 135, that is steps 1305, 1319, and 1325, may be omitted in the procedure illustrated in FIGS. 13A and 13B.

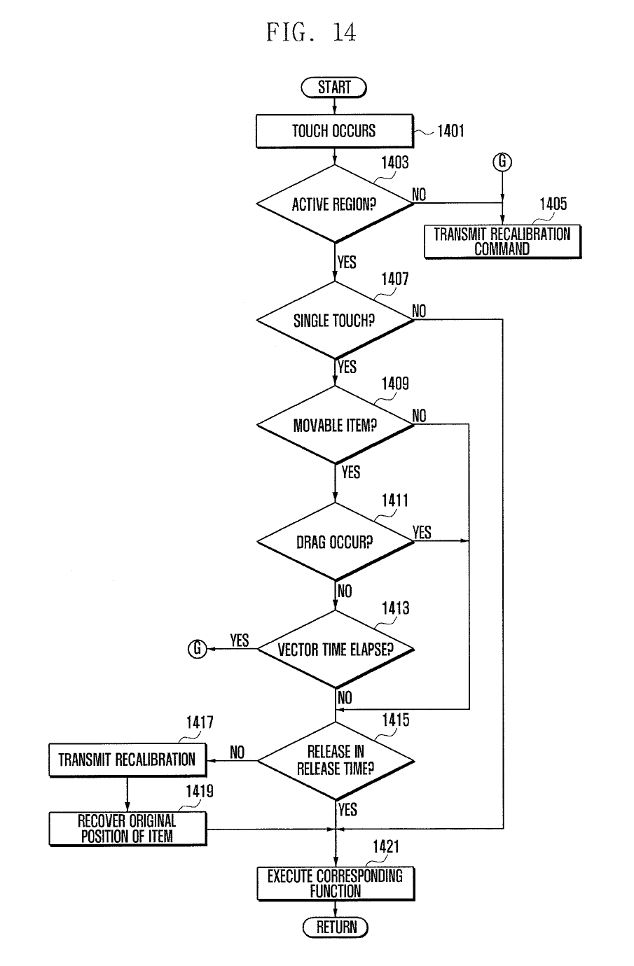

FIG. 14 is a flowchart illustrating a mis-touch avoidance method according to another exemplary embodiment of the present invention.

Referring to FIG. 14, the control unit 110 detects a touch by receiving the touch occurrence message from the touch controller 133 in step 1410. After the touch is detected, the control unit 110 determines whether the touch is made in the active region in step 1403. If the touch is made outside of the active region, then the control unit 110 sends a recalibration command to the touch controller 133 in step 1405. Upon receipt of the recalibration command, the touch controller 133 performs recalibration of the reference value for touch recognition.

If the touch is made in the active region, then the control unit 110 determines whether the touch is single touch in step 1407. If the touch is not a single touch (i.e., if the touch is multi-touch), then the control unit 110 executes the function corresponding to the multi-touch in step 1421. Otherwise, if the touch is single touch, then the control unit 110 determines whether the touch corresponds to a movable item in step 1409. If the touch does not correspond to a movable item, then the procedure goes to step 1415 which is described below. Otherwise, if the touch does correspond to a movable item, then the control unit 110 determines whether the touch is dragged in step 1411. If the touch is dragged, then the procedure goes to step 1415. Otherwise, if the touch is not dragged, then the control unit 110 determines whether a vector time has elapsed in step 1413. If the vector time has elapsed, then the procedure goes to step 1405. Otherwise, if the vector time has not elapsed, then the control unit 110 determines whether the touch is released within a predetermined release time in step 1415. If the touch is not released within the predetermined release time, then the control unit 110 sends the recalibration command to the touch controller 133 in step 1417 and recovers the position of the movable item in step 1419. If there is no movable item displayed on the touch screen 130, or if the touch is made on an item that is not movable item, then step 1419 can be skipped. At step 1421, the control unit 110 executes the function corresponding to the touched area. For example, the control unit 110 may perform the function corresponding to the touch signal input on the touch panel 132 of which a reference value for touch recognition has been recalibrated.

As described above, the mis-touch avoidance method of the present exemplary embodiments is capable of preventing an unintended touch caused by attaching an accessory from causing a malfunction of the mobile terminal. Also, the mis-touch avoidance method of the present exemplary embodiments is capable of preventing the unintended touch made by the user's grip from causing a malfunction of the mobile terminal. Also, the mis-touch avoidance method of the present exemplary embodiments is capable of minimizing a marginal region which is formed at a perimeter of a touchscreen so as to prevent the hand gripping of the mobile terminal from executing a touch on the touchscreen. Furthermore, the mis-touch avoidance method of the present exemplary embodiments is capable of contributing to compact and slim design of the mobile terminal.

The above-described mis-touch avoidance method of the present exemplary embodiments can be implemented in the form of computer-executable program commands and stored in a non-transitory computer-readable storage medium. The non-transitory computer readable storage medium can store the program commands, data files, and data structures in individual or combined forms. The program commands recorded in the non-transitory computer-readable storage medium can be designed and implemented for embodiments of the present invention or used by those skilled in the computer software field.

The non-transitory computer-readable storage medium includes magnetic media such as a floppy disk and a magnetic tape, optical media including a Compact Disc (CD) Read Only Memory (ROM) and a Digital Video Disc (DVD) ROM, a magneto-optical media such as a floptical disk, and the hardware device designed for storing and executing program commands such as ROM, Random Access Memory (RAM), and flash memory. The programs commands include the language code executable by computers using the interpreter as well as the machine language codes created by a compiler. The aforementioned hardware device can be implemented with one or more software modules for executing the operations of the exemplary embodiments of the present invention.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A mis-touch avoidance method for a mobile terminal having a touchscreen, the method comprising:
detecting an attachment of an external device; and
recalibrating a reference value for touch recognition in response to the attachment of the external device.

2. The method of claim 1, wherein the recalibrating of the reference value comprises:
transmitting, from a control unit, a recalibration command requesting recalibration of the reference value to a touch controller;
recalibrating, by the touch controller, the reference value; and
transmitting a recalibration complete message from the touch controller to the control unit to notify the control unit of a completion of the recalibration.

3. The method of claim 2, further comprising ignoring a touch made after the attachment of the external device is detected and before the control unit receives the recalibration complete message.

4. The method of claim 1, wherein the recalibrating of the reference value comprises:
determining whether noise is detected when the external device is attached; and
recalibrating the reference value when noise is detected.

5. The method of claim 4, wherein the determining of whether noise is detected comprises measuring the noise on at least one wire connecting the attached external device.

6. A mis-touch avoidance method for a mobile terminal having a touchscreen, the method comprising:
detecting a touch on the touchscreen;
determining whether the touch is an unintended touch made by a user's grip of the mobile terminal; and
recalibrating a reference value for touch recognition when the touch is the unintended touch.

7. The method of claim 6, wherein the determining of whether the touch is the unintended touch comprises at least one of:
determining whether a size of a contact area of the touch is greater than a first threshold value; and
determining whether a number of channels or coordinates corresponding to a contact point of the touch is greater than the first threshold value.

8. The method of claim 7, further comprising:
determining a touch pressure when the contact area is equal to or less than the first threshold value;
determining whether the touch pressure is greater than a second threshold value; and
recalibrating, when the touch pressure is greater than the second threshold value, the reference value.

9. The method of claim 8, wherein the determining of the touch pressure comprises determining whether a number of channels having a value greater than hysteresis is greater than the second threshold value.

10. The method of claim 6, further comprising:
determining whether the touch is made in a predetermined grip region of the touchscreen; and
regarding the touch made inside the predetermined grip region as the unintended touch and the touch made outside of the predetermined grip region as an intended touch.

11. The method of claim 6, wherein the detecting of the touch and the determining of whether the touch is the unintended touch are performed by a touch controller.

12. The method of claim 11, further comprising transmitting, from the touch controller, a message including a determination result indicating whether the touch is the unintended touch made by the user's grip of the mobile terminal, to a control unit.

13. The method of claim 12, further comprising transmitting, when the touch is made by the user's grip of the mobile terminal, a recalibration command from the control unit to the touch controller.

14. The method of claim 12, wherein the transmitting of the message including the determination result comprises one of:
adding a new field for indicating the determination result to the message; and
setting a reserved bit of an existing field of the message to a value indicating the determination result.

15. The method of claim 13, wherein the detecting of the touch, the determining of whether the touch is the unintended touch, and the recalibrating of the reference value are performed by the touch controller.

16. The method of claim 15, further comprising transmitting, from the touch controller, a message indicating whether to recalibrate the reference value to the control unit.

17. The method of claim 6, further comprising:
determining whether the touch is made in an active region of the touchscreen;
determining, when the touch is made in the active region, whether the touch is the unintended touch; and
recalibrating, when the touch is made outside of the active region, the reference value.

18. The method of claim 17, further comprising:
determining, when the touch is made in the active region, whether the touch is made in a predetermined grip region of the touchscreen;
determining, when the touch is made in the predetermined grip region, whether the touch is the unintended touch; and
executing, when the touch is made outside of the grip region, a function corresponding to a contact area of the touch.

19. The method of claim 17, wherein the recalibrating of the reference value comprises:
determining whether the touch is made in a predetermined grip region of the touchscreen; and
recalibrating, when the touch is made in the predetermined grip region, the reference value.

20. The method of claim 17, further comprising:
determining, when the touch is made in the active region, whether the touch is a single touch;
determining, when the touch is the signal touch, whether the touch is made on a movable item displayed on the touchscreen;
determining, when the touch is not made on a movable item, whether the touch is released in a predetermined release time; and
recalibrating, when the touch is not released in the predetermined release time, the reference value.

21. The method of claim 20, further comprising:
determining, when the touch is not a single touch, whether the touch is an exceptional situation;
recalibrating, when the touch is the exceptional situation, the reference value; and
determining, when the touch is not the exceptional situation, whether the touch is made to a movable item displayed on the touch screen.

22. The method of claim 20, further comprising:
determining, when the touch is made on the movable item, whether the touch is dragged;
determining, when the touch is not dragged, whether a predetermined vector time has elapsed; and
recalibrating, when the vector time has elapsed, the reference value.

23. The method of claim 22, further comprising:
determining, when the touch is dragged, whether the touch is released in the predetermined release time;
recalibrating, when the touch is released in the predetermined released time, the reference value; and
recovering a position of the movable item to an original position of the movable item.

24. The method of claim 20, further comprising:
determining, when the touch is a multi-touch, whether the multi-touch is made in the grip region;
determining, when the multi-touch is made in the grip region, whether a predetermined vector time has elapsed;
recalibrating, when the predetermined vector time has elapsed, the reference value; and
determining, when the predetermined vector time has not elapsed, whether the touch is released in a predetermined release time.

25. The method of claim 22, further comprising:
determining, when the touch is not dragged, whether the single touch is made in the grip region; and
determining, when the signal touch is made in the grip region, whether the predetermined vector time has elapsed.

26. The method of claim 23, further comprising:
determining, when the touch is dragged, whether the single touch is made in the grip region;
determining, when the single touch is made in the grip region, whether the touch is released in the predetermined release time; and
executing, when the single touch is made outside of the grip region, a function corresponding to a contact area of the touch.

27. A mis-touch avoidance apparatus for a mobile terminal, the apparatus comprising:
an interface unit for attachment of an external device;
a touchscreen for detecting a touch; and
a control unit for recalibrating a reference value for touch recognition when the attachment of the external device is detected.

28. The apparatus of claim 27, wherein the touchscreen comprises:
a display unit for displaying images;
a touch panel having a capacitance that varies according to the detected touch; and
a touch controller for controlling the recalibration of the reference value.

29. The apparatus of claim 28, wherein the control unit ignores a touch made after the attachment of the external device is detected and before receiving a recalibration complete message from the touch controller.

30. The apparatus of claim 27, further comprising a noise detector, interconnecting the interface unit and the control unit, and for detecting noise.

31. The apparatus of claim 30, wherein the control unit activates, when the external device is attached, the noise detector and controls, when an interrupt signal notifying of a noise occurrence is received from the noise detector, the recalibration of the reference value.

32. The apparatus of claim 27, wherein the control unit determines, when the touch is detected, whether the touch is an unintended touch made by a user's grip, and controls, when the touch is the unintended touch, the recalibration of the reference value.

33. The apparatus of claim 32, wherein control unit determines whether the touch is made in a predetermined grip region and determines, when the touch is made in the predetermined grip region, the touch to be the unintended touch.

34. The apparatus of claim 32, wherein the control unit determines a size of a contact area of the touch and determines, when the size of the contact area is greater than a predetermined first threshold value, the touch to be the unintended touch.

35. The apparatus of claim 34, wherein the control unit determines, when the size of the contact area is equal to or less than the first threshold value, whether the size of the contact area is greater than a second threshold value and determines, when the size of the contact area is greater than the second threshold value, the touch to be the unintended touch.

36. The apparatus of claim 27, wherein the control unit determines whether the touch is made in an active region displaying icons on the touchscreen and controls, when the touch is made outside of the active region, the recalibration of the reference value.

37. The apparatus of claim 36, wherein the control unit determines, when the touch is made inside the active region, whether the touch is a single-touch,
wherein the control unit determines, when the touch is the single-touch, whether the touch is made on a movable icon,
wherein the control unit determines, when the touch is not made on the movable icon, whether the touch is released in a predetermined release time, and
wherein the control unit controls, when the touch is not released in the predetermined release time, the recalibration of the reference value.

38. The apparatus of claim 37, wherein the control unit determines, when the touch is made to a movable icon, whether the touch is dragged,
wherein the control unit determines, when the touch is not dragged, whether a vector time has elapsed, and
wherein the control unit controls, when the vector time has elapsed, the recalibration of the reference value.

39. The apparatus of claim 38, wherein the control unit determines, when the touch is dragged, whether the touch is released in the predetermined release time,
wherein the control unit recalibrates, when the touch is released in the predetermined release time, the reference value, and
wherein the control unit reverts the movable item to an original position of the movable item.
